(19) United States
(12) Patent Application Publication
(10) Pub. No.: US 2013/0292323 A1
(43) Pub. Date: Nov. 7, 2013

(54) AXIAL FLOW FILTER BLOCK FOR WATER PURIFICATION

(71) Applicants: Thalappil Pradeep, Chennai (IN); Mohan Udhaya Sankar, Cuddalore (IN); N/a Sankar, Culddalore (IN); Amrita Chaudhary, Varanasl (IN)

(72) Inventors: Thalappil Pradeep, Chennai (IN); Mohan Udhaya Sankar, Cuddalore (IN); N/a Sankar, Culddalore (IN); Amrita Chaudhary, Varanasl (IN)

(73) Assignee: INDIAN INSTITUTE OF TECHNOLOGY, Chennai, IN (US)

(21) Appl. No.: 13/877,294

(22) PCT Filed: Sep. 30, 2011
(86) PCT No.: PCT/IB11/02790

§ 371 Date: Jul. 11, 2013

(30) Foreign Application Priority Data
Sep. 30, 2010 (IN) 2892/CHE/2010

(51) Int. Cl. C02F 1/28

(52) U.S. Cl. CPC C02F 1/281
USPC 210/446; 210/484

(57) ABSTRACT

A gravity-fed, axial flow filtration system for treating water is disclosed.

### BACKGROUND

1. Technical Field

The present disclosure relates to the field of water purification, and specifically to gravity-fed axial flow filter blocks used in water purifiers.

2. Technical Background

Adsorption techniques are commonly used for removing contaminants from fluids. Gravity-fed filtration is an easy, cost-effective, and universally adopted method for the purification of drinking water on a domestic scale, and a number of gravity-fed filtration devices and apparatus are currently used for removing contaminants from domestic water.

Various modifications and variations have been proposed for making gravity-fed filtration devices that target the removal of selective contaminants from drinking water. These contaminants include organic contaminants (for example, volatile organics and pesticides), and biological contaminants (for example, bacteria and virus). Removal of these contaminants does not typically require high contact time with the adsorbent. A typical contact time of 10 seconds achieved by known techniques in the prior art (activated carbon based adsorption and use of halogens for disinfection) is typically sufficient to remove such contaminants; however, high contact time (typically more than 2 minutes) is required for the removal of inorganic contaminants such as fluorides, arsenic, and nitrates. When high contaminant concentrations are present, removal using adsorption mechanisms requires a significantly higher contact time than that offered by conventional techniques.

Some of the contaminants in drinking water are geological in origin; whereas others are present due to pollution-based contamination of water sources. There currently exists no single filtration media that can remove all types of contaminants, such as organic contaminants, inorganic contaminants, biological contaminants, and sediments. For removing different contaminants, different types of filtration media are required. The active filtration media can vary from activated carbon to activated alumina, natural/synthetic metal oxides, such as sand, titanium, zirconia, zeolite, magnesia, and different nanoparticle coated metal oxides, etc. To remove specific contaminants, large quantities of adsorbent media are typically required for each contaminant. Homogenizing all these materials together is not possible in large volumes, as they phase separate due to variation in their densities. Moreover, a homogenized mixture cannot offer the contact time required for filtering individual contaminants.

A technical challenge with the gravity-fed water purification is the water pressure available for the flow of water through the porous filtration cartridge. Typically, water head pressure in a gravity-fed water purifier is less than 0.5 lbs/in² at a water head of 34 cm. As reported by Bommi and Bommiin U.S. Pat. No. 7,396,461, a typical water flow rate through 15 mm wall thickness radial flow block is 200 ml/min. Reported data shows that the flow rate drops linearly with increasing wall thickness. Upon extrapolating the linear correlation between flow rate and wall thickness, it is expected that flow rate will become negligible at a wall thickness of 30-35 mm. A wall thickness of 30-35 mm is also not sufficient for multi-contaminant removal. Therefore, modifications in the existing design of gravity-fed water purification cartridge are necessary to target multiple contaminants without losing the flow rate at increased depth.

Although an axial flow block is the solution for efficient removal of contaminants (found in trace as well as high concentration) with complete utilization of the active filtration media, there is no effective flow rate through the block which makes the axial flow block unsuitable under gravity-fed conditions. The decreasing flow rate is attributed to the entry of air inside the porous block upon prolonged use, wherein air bubbles inside the block prevent the flow of water. In in-line or pressurized systems, water pressure is sufficiently high to expel any such trapped air packets. When a primed (air free) condition is reached and maintained, a reduction of flow is prevented. With a gravity-fed filtration apparatus, the water pressure cannot typically displace air packets. Thus, the flow rate drops frequently. This problem is further accentuated in axial flow cylindrical blocks due to increased path length of the block, which is typically 4-15 cm. Moreover, gravity-fed water purifiers known in the art are hydrophobic due to the use of binders that are inherently hydrophobic. The hydrophobic nature of the block increases the difficulty in displacing air with water using gravity pressure.

With such purifiers, the porous axial flow block has to be suitably covered with a housing unit prior to use, wherein the manner in which it is sealed to a solid tube determines the reliability of the filtered water and the manufacturing cost of the unit. Various food grade sealants and cements have been used for this purpose. Production of axial flow blocks is also commercially expensive due to the need for extra manual work, curing time, and costly food grade sealants/cements. Moreover, clogging of pores happens due to sinking of organic based sealants inside the block and the swelling of media such as activated carbon in the solvent used in the sealants.

In axial flow cartridges, fluid flow occurs parallel to gravity. For decades, axial flow cartridges such as carbon cartridges have been made by packing loose granular activated carbon in a column for low pressure drop applications. Such designs are usually employed in community scale filtration units and are typically operated in anti-gravity mode, so that the trapped air can easily be replaced by water. However, packed carbon particle bed system can result in channeling (flow of fluid without contact with the adsorbent media), wherein the water is not treated effectively. Additionally, the use of granular media also affects the performance because the kinetics of adsorption with granular media is slower than that with powder media.

The axial flow porous blocks have been employed to overcome channeling of untreated water. The axial flow blocks have been used in in-line and in mechanically pressurized systems. Although axial flow cylindrical blocks show much better performance, in practice, axial flow carbon blocks are not employed in gravity-fed domestic water purifiers due to increased pressure drop and reduced low flow rate.

Continuity of flow through a porous block upon prolonged use is a problem associated with the degree of wettability. The ease of wettability determines the ease of priming and also influences the flow rate. Wettability is determined by the hydrophilic groups present at the surface. Although filtration medium such as powdered activated carbon has both hydrophilic and hydrophobic surfaces, the final carbon block becomes highly hydrophobic due to hydrophobic nature of the binder used. Hydrophobic binders also increase the cohesive force, further reducing wettability.

The hydrophilicity of the carbon block has been enhanced by a number of ways, such as using additives, but these processes can be prohibitively expensive. In conventional blocks, quantity of the binder used is higher for making a strong block in order to prevent cracking or collapse of block under water pressure over a period of time. When higher quantities of binder are used, wettability decreases due to hydrophobicity, flow rate decreases due to reduced wetting, and removal performance decreases due to surface coverage of active filtration media by binder.

In light of the foregoing discussion, there is a need to address the aforementioned problems and other shortcomings associated with the existing water purification systems. These needs and other needs are satisfied by the water purification systems of the present disclosure.

### SUMMARY

In accordance with the purpose(s) of the invention, as embodied and broadly described herein, this disclosure, in one aspect, relates to a water filtration system. Particularly, the disclosure relates to gravity-fed axial flow filter blocks used in water purifiers.

In one aspect, disclosed are gravity-fed axial flow porous composite blocks for the removal of various contaminants at a desired flow rate. In a further aspect, the present disclosure demonstrates an axial flow block having end-to-end flow prepared directly inside anon-porous/porous filter housing tube.

In another aspect, disclosed is a gravity-fed water purification system. The gravity-fed water purification system includes at least one filtration medium, at least one binder mixed with the at least one filtration medium and a housing tube. A porous composite block is formed by sintering the mixture of the at least one filtration medium and the at least one binder. The composite block is in-situ housed inside the housing tube.

In yet another aspect, disclosed is a method for manufacturing an axial flow block to be used in a gravity-fed water purification system. Moisture is removed from at least one filtration medium. A mixture of the at least one filtration medium and at least one binder is filled in a housing tube. The mixture is heated at a temperature greater than melting point of the at least one binder, whereby a porous block is formed upon cooling of the mixture.

Additional aspects and advantages of the invention will be set forth, in part, in the detailed description and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE FIGURES

The accompanying figures, which are incorporated in and constitute a part of this specification, illustrate several aspects and together with the description serve to explain the principles of the invention.

FIG. 1 depicts an axial composite block filter, in accordance with various aspects of the present disclosure.

FIG. 2 depicts a cross sectional view of an axial, vertical composite block filter, in accordance with various aspects of the present disclosure.

FIG. 3 depicts a three dimensional view of an axial block filter manufacturing system, in accordance with various aspects of the present disclosure.

FIG. 4 depicts a pictorial view of an axial/radial block filter manufactured inside a dome shaped ceramic block, in accordance with various aspects of the present disclosure.

FIG. 5 depicts performance data of an axial block filter made using hydrophobic thermoplastic binder, in accordance with various aspects of the present disclosure, as explained in example C1.

FIG. 6 depicts flow rate data of axial composite block filters made using hydrophilic thermoplastic binder, in accordance with various aspects of the present disclosure, as explained in example C2.

FIG. 7 depicts performance data of an axial carbon block filter for chlorine removal, in accordance with various aspects of the present disclosure, as explained in example D.

FIG. 8 depicts performance data of an axial block filter for fluoride removal, in accordance with various aspects of the present disclosure, as explained in example E2.

### DESCRIPTION

The present invention can be understood more readily by reference to the following detailed description of the invention and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

### DEFINITIONS

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a metal” includes mixtures of two or more metals.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C—F are considered disclosed. Likewise, any subset or combination of these is also disclosed. Thus, for example, the sub-group of A-E, B-F, and C— E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

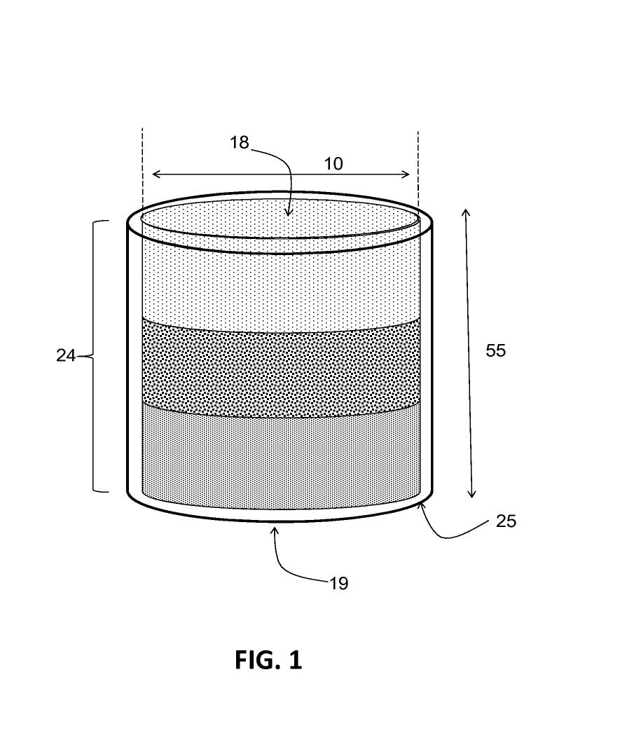

Referring to FIG. 1, a vertical view of an axial flow cylindrical block, in accordance with various aspects of the present disclosure, is shown. The cylindrical block 24 is made by using a sintered material made by mixing active filtration media and binder. An axial flow cylindrical block 24 is supported inside a non-porous/porous housing tube 25. In an aspect of the present disclosure, contaminated water enters through the top end 18, passes through the cylindrical block 24 and the filtered water is collected at the bottom end 19. The entire cross-sectional area of opening (top) end 18 is exposed to water and the collector (bottom) end 19 can be exposed to air or can optionally be closed, and a small opening for water collection can be provided.

In one aspect, the non-porous/porous housing tube 25 having uniform diameter along its length 55. Composite block 24 can be made inside the porous/non-porous housing tube 25. In an aspect of the present disclosure, the maximum height of the axial block 24 is equal to the height 55 of housing tube. In another aspect of the present disclosure, the height of the axial block 24 is less than the height 55. The composite block 24 can be of single active filtration medium or multiple layers of different filtration media, a homogenized mixture of any two or more filtration mediums, or a combination thereof. The non-porous/porous filter housing tube 25 can be used as in-situ mold. The housing tube 25 can be porous or non-porous in various aspects of the present disclosure. The homogenized mixture of active filtration media and any optionally included binder can be filled inside the housing tube 25, sintered to make a porous composite block 24, and sealed with housing tube 25. In one aspect, the non-porous/porous housing tube 25 is thermally and mechanically stable under molding.

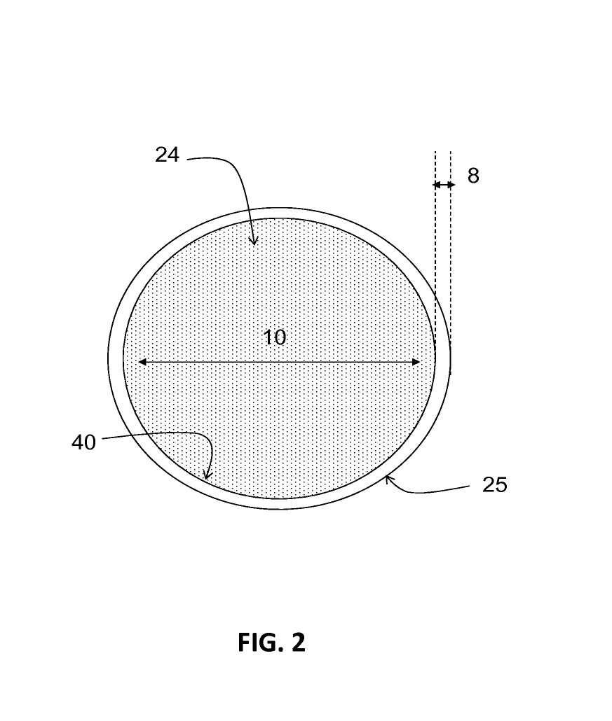

The filter block depicted in FIG. 2 shows the cross-sectional view of an axial flow cylindrical block consisting of composite block 24 having the diameter 10 and a porous or non-porous housing tube 25 having an inner diameter and a wall thickness 8. In one aspect, the diameter 10 of the composite block 24 is determined by the inner diameter of the housing tube 25. In another aspect, the thickness 8 of the housing tube 25 can determine the thermal conductivity and mechanical strength of the tube.

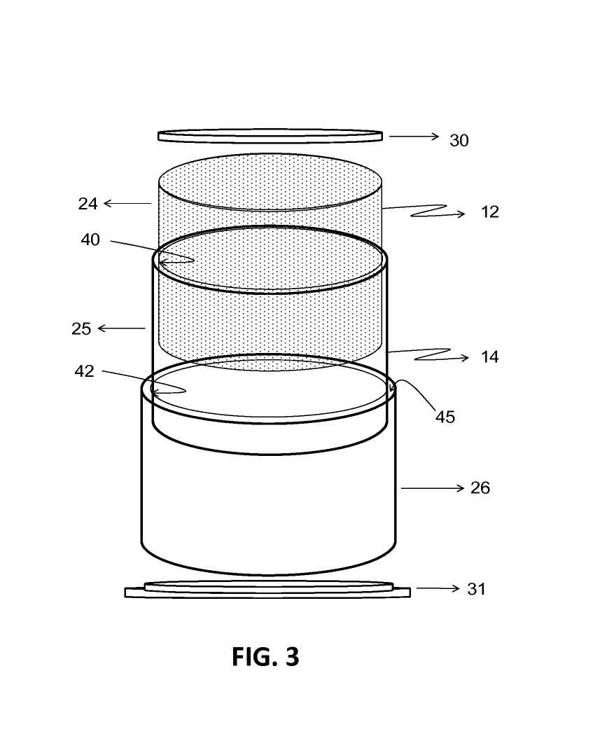

Referring now to FIG. 3, the non-porous/porous housing tube 25, in accordance with an aspect of the present disclosure is shown. The housing tube 25 can be of any shape such as rectangular tube, square tube, triangular tube, oval tube, hemi-spherical tube and so forth. In an exemplary aspect of the present disclosure, a cylindrical tube is used. In one aspect, the tube 25 can be used as in-situ mold and an ex-situ metal mold is not required. In such an aspect, the tube 25 can be placed on a metal disc 31. In one aspect, the active filtration media required for the making of composite block can be oven dried to evaporate all or substantially all of the moisture content therein, mixed with one or more binders at a ratio to obtain a homogenized mixture, and then be packed compactly inside the housing tube. In this aspect, the metal disc 31 fits inside the tube 25 so that material can be easily transported for sintering and other successive processes. The packed mixture takes the dimension of the housing tube used. A movable metal disc 30 can be placed on the packed material and inside the housing tube 25. In one aspect, the diameter of the movable metal disc 30 is lesser than the inner diameter of the tube. In one aspect, the whole element can be sintered at a temperature beyond, for example, the melting point of binder. In another aspect, the inner wall 40 of the tube is bound to the circumferential surface 12 of the block 24 by thermoplastic binders, wherein the thermoplastic binder used to blend the active filtration media also binds with housing tube.

In another aspect, the housing tube 25 can have a bottom closed enclosure. In such an aspect, the metal disc 31 is not required. In one aspect, materials to be blended can be taken inside this cylindrical container and a movable disc 30 placed on the material. After the sintering process, the filter block can be compressed by applying pressure on the movable metal disc 30. The formed composite block can subsequently be cooled, for example, air or water cooled, after which the bottom closure can be removed.

An aspect of the present disclosure also involves a method of making composite block 24 in a porous housing tube 25. During the sintering process, certain binders may not bind with certain active filtration media if (a) the homogenized mixture is directly exposed to air, (b) huge volume of air is present due to loose packing of homogenized mixture, (c) air enters into mixture by any means. When a porous housing tube 25 is used, air can enter the mixture and hence, block 24 cannot be formed properly due to presence of air during the sintering process. In such an aspect, a non-porous thermal conducting container 26 with a wall thickness 45 can be used if a porous housing tube 25 is required. The porous housing tube 25 with an outer diameter 14 fits inside a non-porous thermal conducting container 26 having an inner diameter 42. In such an aspect, the outer diameter 14 of porous tube 25 can be less than the inner diameter 42 of non-porous container 26. Preferably, the difference in diameter can be 500 μm. Preferably, the thickness of non-porous container 26 can be 500 μm and the container can be made of aluminium, iron, brass, stainless steel, or any other alloy. Unlike non-porous tube based block preparation, porous tubes can be covered well inside a non-porous container for better binding.

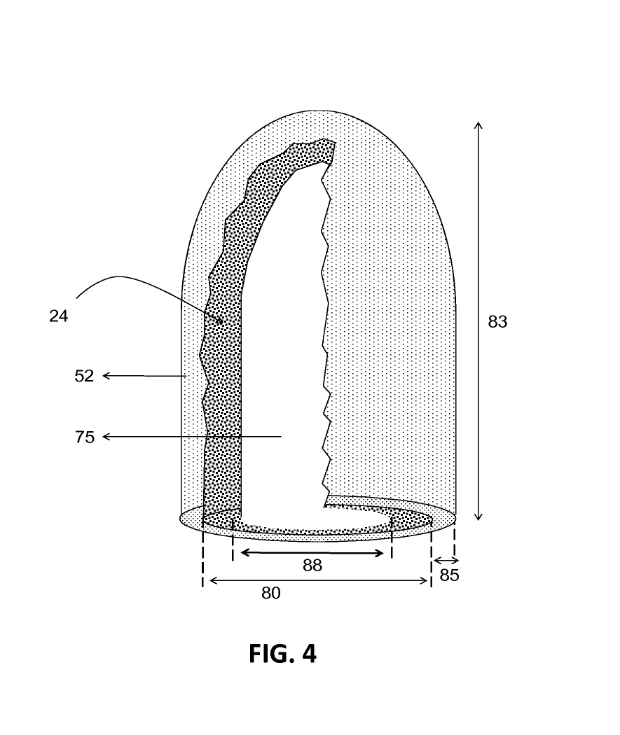

Referring now to FIG. 4, a composite block 24 inside any porous ceramic filter 52 is shown. In this aspect, a ceramic filter 52 having a cylindrical shape with a circumferentially extending sidewall 83 of uniform thickness 85 and a central hollow core 80 with a closed top end and an open bottom end can be used as the tube. In this aspect, the Inner wall of the ceramic filter 52 is bound to the circumferential surface of the ceramic filter 24 by using thermoplastic binders. In various aspects of the present disclosure, the diameter 80 of the central hollow core can vary from a minimum of about 30 mm to a maximum of about 100 mm. In another aspect, the thickness 85 of the circumferentially extending sidewall 83 can vary from a minimum of about 5 mm to a maximum of about 20 mm. In yet another aspect, the height of the circumferentially extending sidewall 83 can vary from about 5 cm to about 20 cm. In still another aspect, the porosity of the ceramic filter can vary from about 0.1 μm to about 50 μm. In various aspects, the composite block 24 can be manufactured in any shape depending upon the shape of the ceramic block filter 52. It will be understood by a person skilled in the art that the ceramic block filter 52 used here can be of any shape and size. It can be porous open ended radial flow, dome shaped radial flow, cone shaped, hemisphere shaped, and so forth. In case of porous ceramic filter 52, a carbon block can be manufactured in a closed environment by keeping the ceramic filter 52 which is filled with active filtration media/binder mixture inside a thermal conducting container 26. The composite block 24 prepared in a ceramic filter 52 can also be bored at the center to create a hollow central core 75 to make it a radial flow block. This radial flow block appears like a dome-shaped, radial flow, composite block having a porous ceramic outer layer.

The diameter of the hollow cylindrical core 88 determines the thickness of the composite block 24.

Disclosed herein is an axial block that operates with the gravity pressure up to about 0.5 psi and has a height/diameter ratio of from about 0.2 to about 3.75. In another aspect, the axial block has an aspect ratio of about 2-3. The ‘height’ is the length of the adsorbent media in the axial flow cartridge through which contaminated water passes. The method of making the block as explained here is such that the water experiences a low pressure drop and the flow rate does not decay with prolonged use. The longer path length introduced in the porous block is meant to deliver improved performance for a given contaminant and also handle multiple contaminants when different filtration media are stacked as layers in the block.

In one aspect, an axial flow cylindrical block as described herein can be fully functional at gravity-fed conditions when the quantity of binder used is reduced from the conventional quantity to a defined value. The present invention is contrary to the knowledge gained from the methods of making conventional radial flow blocks. When the quantity of binder used in conventional block is used in axial flow blocks, flow rate decays very fast. A dramatic increase in flow rate and continuity in flow rate is seen as the quantity of binder used is reduced.

According to the method of the present disclosure, the hydrophilicity of the block can be increased by reducing the quantity of binder used to form the porous block. In one aspect, the axial flow block is housed inside a solid tube. In such an aspect, the circumferential surface of the cylindrical axial block is supported by using the solid tube. As the axial flow block is housed and supported inside the solid tube, the strength of the block is enhanced. Hence, cracking or collapse of the block under water pressure over a prolonged time is prevented. As the housing tube enhances the strength of the block, the quantity of binder required is reduced significantly. Hence, the filtration media to binder weight ratio defined for conventional blocks need not be followed for the making of axial flow cylindrical blocks. Accordingly, strong axial block is made using less quantity of the binder.

In a further aspect, disclosed are methods for making a porous block of various filtration media. Various modifications and variations are done to the known art of making porous blocks. Most filtration media such as activated carbon, activated charcoal, activated alumina, and the like have residual moisture content, as active filtration media tend to absorb moisture over a period of time. The moisture content in the filtration media depends on number of parameters: the method of synthesis, nature of the material, material storage, etc. Moisture content increases the weight of the raw active filtration materials. If moisture is not completely removed before blending with a desired binder, the active filtration media to binder weight ratio increases post production. Hence, after sintering process, the weight ratio of binder in porous block is higher than the desired/calculated weight, further increasing the hydrophobicity of the resulting block. Moreover, when filtration media containing a high moisture content is blended with the binder, the sintering time has to be increased in order to evaporate the moisture and then melt the binder. In addition, the filtration media to binder weight ratio differs enormously from medium to medium based on their density, surface roughness, shape and size. Accordingly, in the present disclosure, all the active filtration media are dried to remove moisture, weighed as per desired ratio and used for making the block. In another aspect, an active filtration medium or mixture of active filtration media can be provided in a dried state, comprising no or substantially no moisture.

In view of the above, the present disclosure describes a method of making a mold-less axial flow porous composite block. In one aspect, a non-porous/porous filter housing tube is used as in-situ mold, wherein the block is sealed inside the housing tube by coating a layer of a thermoplastic binder in the inner diameter of the housing tube. In such an aspect, the use of ex-situ metal molds is avoided. In such an aspect, the composite block is made by mixing a suitable binder with an active filtration media such as activated carbon, activated charcoal, activated alumina, sand, metal oxide nanoparticle loaded activated alumina/carbon, metal nanoparticle loaded activated alumina/carbon, ion exchange resin beads, compositions of micron size metal oxides such as silica, titanium, manganese oxides, zeolite and the like, and combinations thereof. In another aspect, the composite block can be made by using a single active filtration medium, multiple layers of the same or different filtration media, or a homogenized mixture of all filtration media. In yet another aspect, multiple layers of media can be used wherein each individual layer can comprise a single or a mixture of individual media.

In a further aspect, a non-porous or porous filter housing tube can be used as the in-situ mold, wherein the housing tube is porous or non-porous depending upon the requirements and intended application. In one aspect, a non-porous or porous tube can have multiple layers of different filtration media or a homogenized mixture of active filtration media and suitable binder. In this aspect, the whole mixture can be sintered at a temperature near the melting point of the binder used. In yet another aspect, the inner wall of the housing tube can be fully or at least partially coated with a thermoplastic binder. Upon heating during the process of block making, the thermoplastic binder can melt and develop a strong contact between the circumferential surface of the block and the inner wall of the housing tube. Thus, the thermoplastic binder used to blend the active filtration media can also bind with the housing tube. In another aspect, the non-porous and/or porous housing tube is thermally and mechanically stable under molding.

When an axial flow cylindrical block is made withbinder to filtration media ratio of 20:80 and sealed inside a solid housing tube using sealants, its flow rate decays very fast and the quantity, in liters, filtered at consistent flow rate is very small (referred to as the ‘reference value’). In contrast, when a similar cylindrical block is run in an in-line or mechanically pressurized condition or gravity-fed radial flow mode (e.g., bored at the core), the flow rate can be consistent for a long duration. Similarly, when the binder weight to filtration media ratio is greater than 20:80 (for example, 25:75, 30:70, 40:60, etc.), the functionality of the axial cylindrical block further worsens as compared to the functionality of the cylindrical block with a weight to filtration media ratio of, for example, 15:85. This finding is common for all axial flow cylindrical blocks made using any filtration medium such as activated carbon, activated alumina, metal oxide, etc., blended with a binder such as ultra-high-molecular-weight polyethylene (UHMWPE), high-density polyethylene (HDPE), and the like.

In one aspect, the binder to filtration media ratio cannot be reduced to an extremely low value which can adversely affect the strength and/or stability of the block when used for water purification.

The following observations have been made for axial flow cylindrical blocks.

### Observation A

In general, higher weight percentages of binder result in more rapid reduction in the flow rate exhibited by the axial flow blocks. It was the typical use of higher weight percentages of binder were apparently necessary due to the presence of moisture content in the filtration media and the need for higher strength. A review of conventional filtration media such as activated carbon, activated charcoal, activated alumina and the like, revealed that most had 1-10% moisture content. Active filtration media usually absorb moisture over a period of time as they are highly porous and have hydrophilic group at their surfaces. When the active filtration media were produced by one of wet chemical methods, surface modified by wet chemical methods, and surface loaded with another material by wet chemical methods, the amount of moisture in the filtration media was higher. The moisture content increased the weight of the active filtration raw materials. Moisture content in media differs from one medium to another medium. After the block production, there was a change in the actual active filtration medium to binder weight ratio because of the incomplete removal of moisture before blending with desired binder. Consequently, after the sintering process, the weight ratio of binder in porous block is higher than the desired or calculated weight. This in turns increases the hydrophobicity of the block. In view of the above, in the aspects of the present disclosure, all the active filtration media are, in one aspect, dried to remove moisture prior to block making.

### Example A1

80 g of raw powdered active filtration medium and 20 g of suitable binder were taken in the ratio of 20:80 and homogenized. An axial block was molded at a temperature higher than melting point of the binder used, maintained for 90 minutes and subsequently air-cooled. The molded axial block was weighed again and a 10% decrease in the theoretical weight was observed. Therefore, the binder to media weight ratio changed from 20:80 to 22.22:77.78, i.e., the binder weight has increased by 11%.

### Example A2

As determined in example A1, in another aspect of the present disclosure, the axial blocks were made by the following method. Powdered active filtration medium was dried at 100° C. for an hour. Filtration medium can be any material, for example, activated carbon is taken in this example. The filtration medium to binder weight ratio of 10:90 was measured, the mixture homogenized, and the axial block was made. The axial block was subsequently molded. The molded block was weighed again and negligible difference in theoretical weight was observed.

### Observation B

As determined in observation A, in an aspect of the present disclosure, the axial blocks were prepared by first removing moisture from the active filtration media to achieve the desired weight ratio. As the binder weight percentage was increased, the extent of flow rate reduction was found to be higher when the block was sealed inside a solid tube. It was observed that the displacement of air by water became difficult in such an axial block. The depth is maximum in axial flow cylindrical block, compared to the depth in the conventional blocks. In an axial block, air moves upwards and water moves downwards. The increase in the depth of the axial block reduces the complete displacement of trapped air from the block. On increasing the binder quantity, the block becomes hydrophobic as most binders are hydrophobic in nature. The insufficient displacement of trapped air in the block and the force exerted by inefficient flow of water through the hydrophobic block could be the reasons for the frequent choking and less flow rate. If this is to be assumed, an axial block having height to diameter aspect ratio between 2 and 3 cannot offer the desired flow rate and continuity of the flow rate. Additionally, it was found that the method by which the block was sealed can affect the performance of the block.

An axial flow block was molded and sealed in a tube using suitable sealants. Various food grade sealants, such as epoxy resins, silicone sealants, cements, etc., were used. It was found that the same dimensions of the blocks prepared under same condition showed different flow rates with different sealants. The expected flow rate was not obtained from any of the above sealants. It was found that the used sealants sank inside the block depending upon their viscosity and solvent used to cure them. Hence, there was loss in the quantity of the material used, reduction in actual diameter and likely closure of pores.

### Example B1

As determined in examples A1 and A2, powdered activated carbon was dried and used. A carbon to binder weight ratio of 20:80 was measured and the mixture homogenized. A total of three blocks were made. Two blocks were made inside a metal mold at a temperature above the melting point of the binder and maintained at that temperature for 90 minutes, followed by air-cooling. One block was sealed inside a non-porous solid tube using epoxy resins and the other block was sealed using a silicone sealant. Both the blocks were run in axial flow mode. The third block was prepared directly inside the silicone extrusion tube. The block sealed inside a non-porous solid tube using epoxy resin choked earlier than the one sealed using silicone sealant which choked earlier than the one prepared directly inside the tube. As determined in example B, a cost-effective, easy and fast making of an axial flow cylindrical block is demonstrated. Instead of first making the axial block using a metal mold and sealing it subsequently inside a non-porous solid tube using non-toxic sealants/cement, a method for uniting both the molding steps and sealing step in a single embodiment was performed. Homogenized filtration media and binder can be taken inside a solid non-porous tube. This non-porous solid filter housing tube was used as in-situ mold and was in-situ sealed to the axial block by heat. The non-porous tube did not melt under the molding temperature. In this example, the inner wall of the tube is bound to the circumferential surface of the block by thermoplastic binders, and the thermoplastic binder used to blend the active filtration media also binds with the housing tube. If needed, the binder particles can be first spray coated on the inner surface of the tube before filling the homogenized media.

### Observation C

As understood from observation B, the two necessary factors for operating an axial block under gravity are the continuous flow of water through porous block with ease and complete ejection of air from the block. The process of expelling the trapped air from an axial block and maintaining an “air-free” condition in gravity-fed filtration block depends on the ease of wetting. Apart from pore size, the flow rate through the carbon block depends on the wettability of the block. The wettability is determined by the chemical groups that are present at the surface. Hydrophilic groups enhance the adhesion force by reducing the surface tension arising due to the cohesive force. Despite the fact that active filtration media have hydrophilic surfaces, the final axial block becomes highly hydrophobic, as the binders used are hydrophobic in nature. Hydrophobic binder increases the cohesive force and hence the wettability decreases. When the binder weight percentage is high in the block, hydrophobicity of the block increases. As a result of the increase in the binder quantity, wettability decreases as a result of hydrophobicity, flow rate decreases due to worsening of wetting, and hence priming becomes difficult. Quantity of binder determines the strength of the block. The axial flow block is housed inside a solid tube. The circumferential surface of cylindrical axial block is supported by the solid tube. The structural integrity/strength of the axial block is based on the solid tube. Hence, cracking or collapse of the block under severe water pressure over a period is not possible. The quantity of binder required is reduced as covering the tube enhances the strength of the block. For this reason, the media/binder ratio defined for conventional blocks need not be followed for the making of axial flow cylindrical blocks. Consequently, a strong axial block is made using less quantity of binder.

### Example C1

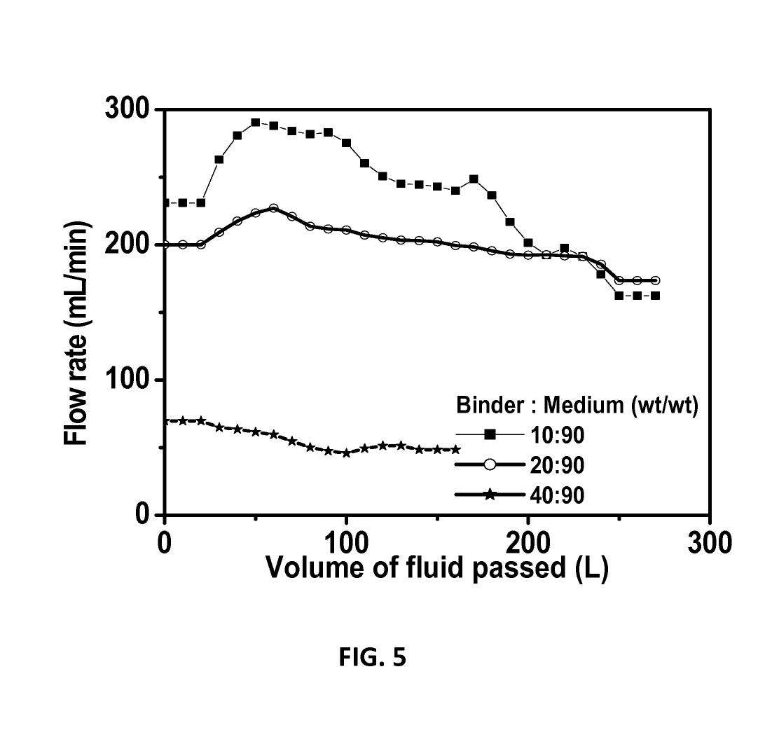

In this example, a dried powdered filtration medium and a hydrophobic binder were used. The binder to filtration medium weight ratios of 10:90, 20:80 and 60:40 were measured and the mixture homogenized. Three blocks were made inside a metal mold at a temperature above the melting point of the binder and the temperature maintained for 90 minutes. The blocks were subsequently air-cooled. All three blocks were sealed inside a non-porous solid tube. For simplicity, blocks were cut into 50 mm diameter and 70 mm height (i.e., height/diameter ratio of 1.4). All three blocks were run in axial flow mode. All the blocks were allowed to run continuously without any maintenance (periodic backwashing) until the flow rate dropped significantly. The block having the weight ratios of 10:90, 20:80 and 60:40 exhibited the flow rates of 296 mL/min, 240 mL/min and 80 mL/min, respectively. FIG. 5 depicts performance data (average flow rate) of the axial blocks made using hydrophobic thermoplastic binder, in accordance with this aspect of the present disclosure. It is evident that increasing the hydrophobic binder percentage decreases the flow rate and the continuity of the flow. It was observed that the block having the hydrophobic binder to medium weight ratio of 40:60 chocked within 150 L.

### Example C2

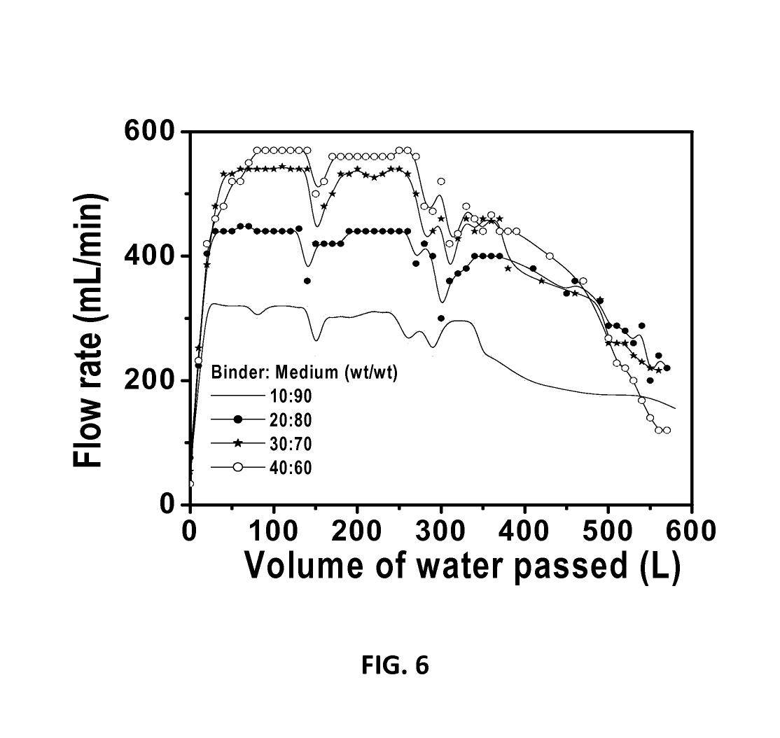

In this example, dried powdered filtration medium and a hydrophilic binder were used. The binder to medium weight ratios of 10:90, 20:80, 30:70 and 60:40 were measured and the mixture homogenized. All blocks were made inside a metal mold. The blocks were subsequently air-cooled. All three blocks were sealed inside a non-porous solid tube. For simplicity, blocks were cut into 50 mm diameter and 70 mm height. All the blocks were run in axial flow mode. All the blocks were allowed to run continuously without any maintenance (periodic backwashing) until the flow rate dropped significantly. The blocks having the weight ratio of 10:90, 20:80, 30:70 and 60:40 showed flow rates of 320 mL/min, 440 mL/min, 530 mL/min and 570 mL/min, respectively. The average flow rate is depicted in FIG. 6. It is evident that increasing the hydrophilic binder percentage increases the flow rate due to affinity towards water. It was observed that all the blocks ran for at least 500 L without any choking in the flow rate even without any maintenance (periodic backwashing). This confirms that hydrophilic binder indeed increases the flow rate and longevity of life.

In one aspect, tt should be noted that an axial flow block having the binder to media weight ratio equal to or below 5:95 can be made if the molding temperature is significantly higher than the melting temperature of the binder. It should also be noted that binder to media weight ratio and the molding temperature are determined by the melt flow index of the binder used. In the present aspect, the molding temperature, binder to media weight ratio, molding duration and compression level are not universally fixed. All of these parameters vary from binder to binder, media to media and binder to media. All of these parameters were optimized for each binder for enhanced priming.

In one aspect, a gravity-fed axial flow cylindrical block can be positioned vertically or horizontally. In a vertical mode, the axial block can have downward water flow (in the direction of gravity) or upward water flow (in the direction opposite to gravity). In the horizontal mode, the axial block has water flow perpendicular to gravity and block can be kept in, for example, perfect horizontal position or in a slightly tilted position.

In another aspect, a cost-effective, easy and fast making of an axial flow cylindrical block is demonstrated. Instead of first making the axial block using a metal mold and sealing it subsequently inside a non-porous solid tube using non-toxic sealants/cement, a method for uniting both the molding steps and sealing step in a single aspect was performed. In one aspect, a non-porous/porous solid filter housing tube was used as in-situ mold and in-situ sealed by heat. The non-porous/porous tube used does not melt under the molding temperature, and the inner wall of the tube is bound to the circumferential surface of the block by thermoplastic binders. In such an aspect, the thermoplastic binder used to blend the active filtration media also binds with the housing tube. In an optional aspect, the binder particles can be first spray coated on the inner surface of the tube before filling the homogenized media. The so-called non-porous tube can have a closure at one end like a cylindrical container.

A person skilled in the art will appreciate that the non-porous/porous housing tube defined, can be made up of earthenware, stoneware, porcelain, ceramic filter tube, nylon, Teflon, fibre reinforced plastic, high density polyethylene (HDPE), ultra high molecular weight polyethylene (UHMWPE), polypropylene (PP), polyvinyl chloride (PVC), ultra polyvinyl chloride (UPVC), and the like, depending upon the requirement and the sintering temperature. When binder such as UHMWPE are used, tubes such as earthenware, stoneware, porcelain, ceramic filter tube, nylon, Teflon, fibre reinforced plastic and the like can be used.

Further, the composite block can be made by using any suitable thermoplastic binder with any active filtration media such as activated carbon, activated charcoal, activated alumina, sand, metal oxide/hydroxide nanoparticle loaded activated alumina/carbon, metal nanoparticle loaded activated alumina/carbon, ion exchange resin beads, any composition of micron size metal oxides such as silica, titanium, manganese oxides, zeolite and metal hydroxides such as boehmite, iron oxide-hydroxide, and various combinations thereof.

The aspects of the present disclosure have the design flexibility to target particular contaminants for the effective and complete removal and to target more than one type of contaminant in domestic water such as organic, inorganic and biological depending upon the filtration media used.

In an exemplary aspect of the present disclosure, activated carbon is used as the filtration medium. Activated carbon manufactured from any source such as bituminous coal, nut shell, coconut shell, corn husk, polymers, wood, and the like can be used in the present aspect. Activated carbon used here can be of any carbonaceous material activated by physical treatment, chemical treatment, and the like. In various aspects, the surface area of the powdered activated carbon can be greater than about 700 m²/g, or greater than about 1,000 m²/g.

In another aspect, the mesh size of any filtration media can be about U.S. mesh 20×325. In one aspect, media having particles not more than 5% passes through a sieve of U.S. mesh 200, not more than 60% passes through a sieve of U.S. mesh 100 and not more than 5% is retained on a sieve of U.S. mesh 50.

In yet another aspect, an axial flow cylindrical activated carbon block showed complete removal of chlorine from domestic water using less amount of media than in a conventional block.

### Example D

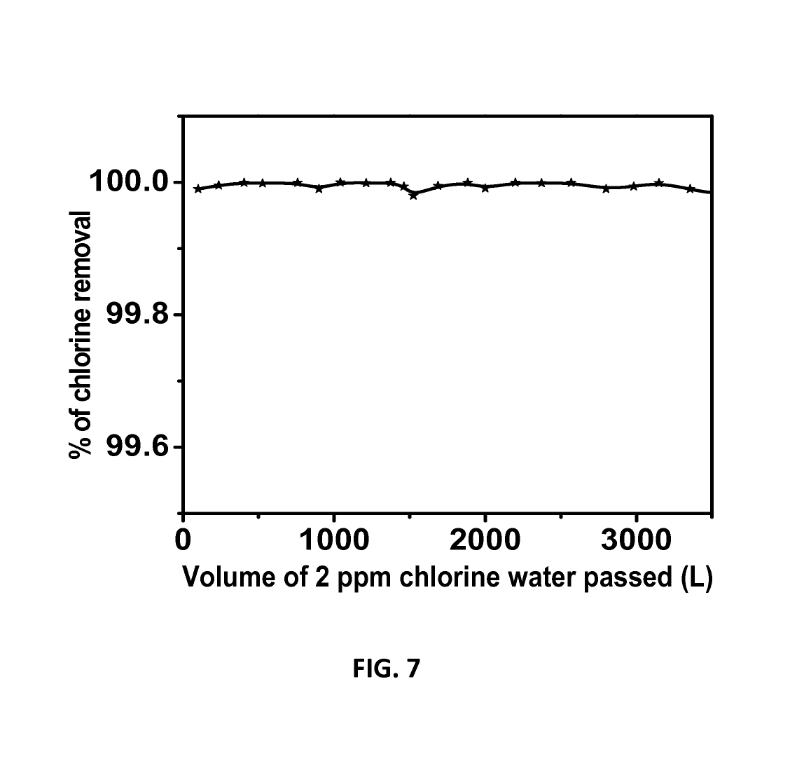

In this example, 30 g powdered activated carbon was dried at 100° C. for an hour, and UHMWPE was used as the binder. The binder to carbon weight ratio, preferably in the range of 8:92 to 14:86, was measured and the mixture homogenized. A non-porous cylindrical housing tube such as a nylon tube having a closed end was used. The inner surface was pre-coated with binder particles and was filled with the homogenized mixture of carbon and binder. It was heated to a temperature such that the core of the housing tube filled with mixture was above the melting point of the binder used. The heating was carried out for 90 minutes, and it was then cooled to room temperature. The bottom closure of the housing tube was then removed to obtain an end-to-end axial flow. An axial carbon block having 50 mm diameter and 35 mm height (i.e., height/diameter ratio of 0.7) was obtained and was run in vertical mode. At least 3,000 L of a 2 ppm chlorine aqueous solution was passed through the carbon block. The percentage of removal is depicted in FIG. 7. In this aspect of the present disclosure, the filter block showed the removal performance of more than 99.9% constantly. While not wishing to be bound by theory, it is believed that the consistent performance of 30 g carbon block at desired flow rate is largely due to increased depth of the axial block.

In one aspect, when powdered activated carbon was used, the binder content was in the range of about 5-20%, by weight. In another aspect, the binder content was about 8-12% by weight. In another aspect, when activated alumina/nanoparticle loaded alumina was used, the binder content was in the range of about 3-10% by weight. In another aspect, the binder content was about 4-6% by weight. The binder particles were in the range of approximately about 20-200 μm. In another aspect, the size of the binder particles matched or approximated the media size.

In one aspect, the axial flow cylindrical block can be prepared using mixed binders. In this case, the melting point of any one of the binder is significantly higher than another one. Hence, only one binder melts and binds with the filtration media during molding process and another binder remains un-melted. In such an aspect, the un-melted binder used can have a young's modulus lower than or substantially lower than filtration media and remaining binder.

The axial cylindrical block can be of single active filtration media, multiple layers of different filtration media, a homogenized mixture of filtration media, or a combination thereof. Different binder ratios can also be used for different filtration media, and one of skill in the art could readily determined, based on this disclosure and with routine optimization, an appropriate binder ratio.

### Example E1

In this example, powdered activated carbon, activated alumina, silver nanoparticle loaded metal oxides were dried at 100° C. for an hour. A common binder was used for all media. In this example, the binder to carbon weight ratio is between 8:92 to 14:86, the binder to alumina weight ratio is between 3:97 to 10:90, the binder to silver nanoparticle loaded metal oxides weight ratio is between 3:97 to 10:90. The samples were measured and homogenized separately. A non-porous solid tube, inner surface pre-coated with and without binder particle was used. Homogenized filtration media were packed inside the tube one over the other, and heated to a temperature above the melting point of the binder used and maintained for 90 minutes. It was subsequently cooled to the room temperature. An axial composite block with 75 mm diameter and 110 mm height (i.e., height/diameter ratio of 1.46) was run in vertical mode. Prepared block was tested for anti-bacterial activity. E. coli was used as a model microorganism. The performance data is given in Table 1. E. coli at the concentration of 5×10⁵ CFU/mL, was continuously passed through the composite filter. It was observed that ˜99.9% removal was seen up to 300 L. It should be noted that filter capacity can be increased by increasing the quantity of adsorbent used. The values represented here do not reflect the capacity of the filter, but prove the performance at highest concentration of contaminants.

TABLE 1
Performance Data for Example E1

| | VOLUME OF | | | |
|---|---|---|---|---|
| Sr. | FEED WATER | INPUT | OUTPUT | % OF |
| No. | PASSED | CFU/mL | CFU/mL | REMOVAL |
| 1 | 10 | 5 × 10⁵ ± 500 | 16 ± 10 | 99.9988 |
| 2 | 50 | 5 × 10⁵ ± 500 | 28 ± 10 | 99.9944 |
| 3 | 70 | 5 × 10⁵ ± 500 | 65 ± 10 | 99.9870 |
| 4 | 140 | 5 × 10⁵ ± 500 | 32 ± 10 | 99.9936 |
| 5 | 185 | 5 × 10⁵ ± 500 | 96 ± 10 | 99.9808 |
| 6 | 240 | 5 × 10⁵ ± 500 | 171 ± 10 | 99.9658 |
| 7 | 300 | 5 × 10⁵ ± 500 | 596 ± 10 | 99.8808 |

### Example E2

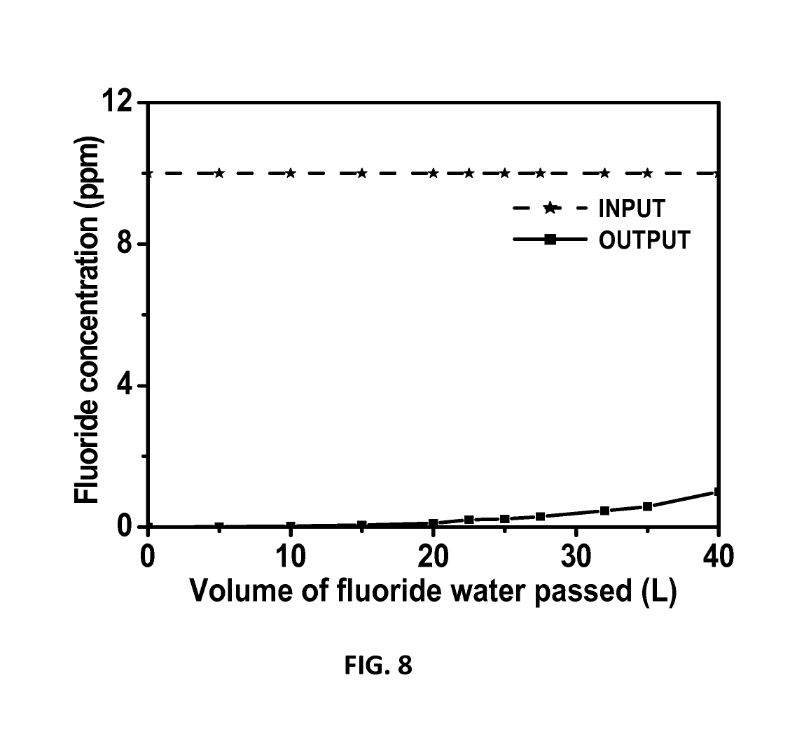

In this example, powdered activated carbon, silver nanoparticle loaded metal oxides and fluoride removal media were dried at 100° C. for an hour. A common binder was used for all the media. In this example, the binder to carbon weight ratio is between 8:92 to 14:86, binder to silver nanoparticles loaded metal oxides weight ratio is between 3:97 to 10:90, binder to fluoride removal media weight ratio is between 5:95 to 15:85. The samples were measured and homogenized separately. A non-porous solid tube, inner surface pre-coated with and without binder particle was used. Homogenized filtration media were packed inside the tube one over the other. It was heated to a temperature above the melting point of the binder used and maintained for 90 minutes. It was then cooled to the room temperature. An axial composite block with 46 mm diameter and 150 mm height (i.e., height/diameter ratio of 3.2) was run in vertical mode. Prepared composite axial block was tested for fluoride removal capacity. 10 ppm fluoride solution was filtered through the block. The performance data are depicted in FIG. 8. The fluoride contaminant permissible limit in drinking water is typically up to 1 ppm. FIG. 4 shows that the filter ran for 40 L with acceptable performance. It should be noted that filter capacity can be increased by increasing the quantity of adsorbent used. The values represented here do not conclude the capacity of the filter, but prove the performance at highest concentration of contaminants.

In one aspect, the axial flow cylindrical block can be prepared using mixed binders. In this aspect, the melting point of any one of the binders can be significantly higher than any other binder used. Hence, only one binder melts and binds with the filtration media during a molding process and another binder remains non-melted. In this aspect, the non-melted binder used can be softer in nature (having a low compressive strength) than the filtration media. The mixed binders can be mixture of hydrophilic plastics or of hydrophilic and hydrophobic plastics.

### Example F

In another example, the following method demonstrates the procedure to form a composite axial block using mixed binders. The specified nature of binders and their weight ratio are only meant for illustrative purposes.

In this example, dried powdered medium, hydrophilic binder, and hydrophobic binder were used. The hydrophilic binder to hydrophobic binder to medium weight ratios of 15:5:80 were measured and the mixture homogenized. A non-porous solid tube, inner surface pre-coated with binder particle was used. The resulting homogenized filtration media with binder was then packed inside the tube and heated to a temperature above the melting point of the hydrophilic binder but below the melting point of hydrophobic binder used and maintained for 90 minutes. It was then cooled to the room temperature.

In one aspect, an axial block and/or radial block can also be made directly inside a porous solid tube. Although the present disclosure discusses the axial flow block in detail, it will be understood by a person skilled in the art that a radial flow block can also be made by using the above described method, without departing from scope and spirit of the present disclosure.

### Example G

In this example, powdered activated carbon was dried at 100° C. for an hour. In this example, the binder to carbon weight ratio can be between 8:92 to 40:60, or about 20:80. The binder and carbon were measured and mixture homogenized. A porous, dome shaped commercial ceramic filter candle was used. Homogenized filtration media was packed inside the tube and heated so that the temperature at the core of the tube was above the melting point of the binder used. It was maintained for 90 minutes. It was subsequently cooled to the room temperature, and then the ceramic candle filled with carbon block was bored at the core to make a hollow cylindrical core.

The present disclosure also has a proficiency to solve the well-known wall effect often seen in granular media filter devices. To arrest the wall effect (easy channeling of water at the junction of media and inner wall of media container), the sealing method above described in examples D, E1, E2, & F can be carried out. The granular media used for filtration purpose is pre-coated at the surface of the housing tube using suitable binder. This method can be commonly used for all types of filter devices having loosely packed filter media.

### Example H

In this example, a desired housing tube in a desired dimension was used. A thermoplastic binder of U.S. mesh 50×150 having high melt-flow index was coated on the inner surface of the housing tube. The granular media to be used was filled inside the pre-coated housing tube densely and heated above the melting point of the binder used to stick the granular media to the housing tube.

The described aspects are illustrative of the invention and not restrictive. It is therefore obvious that any modifications described in this invention, employing the principles of this invention without departing from its spirit or essential characteristics, still fall within the scope of the invention. Consequently, modifications of design, methods, structure, sequence, materials and the like would be apparent to those skilled in the art, yet still fall within the scope of the invention.

### ADVANTAGES

The present invention offers one or more of the following advantages. The cylindrical block has a height/diameter aspect ratio significantly greater than conventional block filters for water flow, so as to have sufficient contact time for complete removal of various contaminants. The filter block does not suffer from low flow rate and frequent choking problems as experienced by other gravity-fed purifiers. The filter block is easy to make and cost-effective, avoids extra manual work, curing time and costly food grade sealants/cements.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-52. (canceled)

53. A gravity-fed water purification system comprising:
at least one filtration medium;
at least one binder mixed with the at least one filtration medium; wherein a porous composite block is formed by sintering the mixture of the at least one filtration medium and the at least one binder; and
a housing tube, wherein the composite block is disposed within the housing tube.

54. The gravity-fed water purification system of claim 53, wherein the at least one binder is thermally bound to an inner surface of the housing tube.

55. The gravity-fed water purification system of claim 53, wherein the mixture is heated at a temperature greater than melting point of the at least one binder, whereby a porous block is formed upon drying of the mixture.

56. The gravity-fed water purification system of claim 53, wherein hydrophilicity of the at least one filtration medium is increased.

57. The gravity-fed water purification system of claim 53, wherein hydrophilicity of the at least one filtration medium is increased by reducing a quantity of the at least one binder.

58. The gravity-fed water purification system of claim 53, wherein the porous cylindrical block is directly formed inside the housing tube, without using an external mold.

59. The gravity-fed water purification system of claim 53, wherein the at least one active filtration medium comprises at least one of an activated carbon, an activated charcoal, an activated alumina, a sand, a metal oxide or hydroxide nanoparticle loaded activated alumina or carbon, a metal nanoparticles loaded activated alumina or carbon, an ion exchange resin bead, a composition of micron size metal oxides, a metal hydroxide, or a combination thereof.

60. The gravity-fed water purification system of claim 59, wherein the composition of micron size metal oxides comprises one or more of silica, titania, magnesia, ceria, manganese oxide, zeolites, or a combination thereof.

61. The gravity-fed water purification system of claim 59, wherein the metal hydroxide comprises at least one of a boehmite and an iron oxide-hydroxide.

62. The gravity-fed water purification system of claim 53, wherein the sintering of the mixture is performed at a temperature of at least about 100° C.

63. The gravity-fed water purification system of claim 53 wherein at least a second filtration medium is blended with the at least one filtration medium.

64. The gravity-fed water purification system of claim 53, wherein the housing tube is used for in-situ molding of the mixture of the at least one filtration medium and the at least one binder.

65. The gravity-fed water purification system of claim 53, wherein the housing tube is porous.

66. The gravity-fed water purification system of claim 53, wherein the housing tube is non-porous.

67. The gravity-fed water purification system of claim 53, wherein the housing tube comprises at least one of non-porous earthenware, stoneware, porcelain, nylon, Teflon, fiber reinforced plastic, high density polyethylene (HDPE), ultra high molecular weight polyethylene (UHMWPE), PP, polyvinyl chloride (PVC), ultra polyvinyl chloride (UPVC), silicone, or a combination thereof.

68. The gravity-fed water purification system of claim 53, wherein the housing tube comprises at least one of porous earthenware, ceramic filter candle, polymeric filter candle, or a combination thereof.

69. The gravity-fed water purification system of claim 53, wherein a shape of the housing tube is one of an open ended cylinder, a dome, a cone, or a hemisphere.

70. The gravity-fed water purification system of claim 53, wherein the composite block is positioned vertically.

71. The gravity-fed water purification system of claim 53, wherein the composite block supports one of a downward or an upward water flow direction.

72. The gravity-fed water purification system of claim 53, wherein the composite block is positioned substantially horizontally.

73. The gravity-fed water purification system of claim 53, wherein the composite block is positioned at an angle with horizontal.

74. The gravity-fed water purification system of claim 53, wherein the composite block supports one of a downward and an upward flow direction.

75. The gravity-fed water purification system of claim 53, wherein a hollow central core is formed by drilling a hole in the axial flow cylindrical block.

76. The gravity-fed water purification system of claim 53, wherein the at least one binder is pre-coated by heating.

77. The gravity-fed water purification system of claim 53, wherein the gravity-fed water purification system is a granular media filtration device.

78. The gravity-fed water purification system of claim 53, wherein the at least one filtration medium comprises no or substantially no moisture.

79. A method for manufacturing an axial flow block to be used in a gravity-fed water purification system, the method comprising:
providing at least one filtration medium comprising no or substantially no moisture;
filling a mixture of the at least one filtration medium and at least one binder in a housing tube; and
heating the mixture at a temperature greater than melting point of the at least one binder, whereby a porous block is formed upon drying of the mixture.

80. The method of claim 79, wherein the step of providing at least one filtration medium comprises provided a filtration medium comprising moisture, and removing all or substantially all of the moisture from the at least one filtration medium.
